(19) United States
(12) Patent Application Publication
(10) Pub. No.: US 2002/0018491 A1
(43) Pub. Date: Feb. 14, 2002

(54) PLUG-IN MULTIPLEXER

(76) Inventor: NICHOLAS A. BALATONI, SANTA CLARA, CA (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 08/949,061

(22) Filed: Oct. 10, 1997

Related U.S. Application Data
(63) Continuation-in-part of application No. 08/408,020, filed on Mar. 20, 1995, now Pat. No. 5,917,814.
(63) Continuation-in-part of application No. 08/485,460, filed on Jun. 7, 1995.
(60) Provisional application No. 60/028,113, filed on Oct. 11, 1996.

(51) Int. Cl. H04J 3/04

(52) U.S. Cl. 370/485; 370/535; 370/420

(57) ABSTRACT

A system for use with a subscriber line carrier such as a SLC-5 or other SLC type system. In accordance with a specific embodiment, the system provides a multiplex channel unit 25 that inputs T1 line signals, and outputs multiple telephone line signals in a format such as 2B1Q or 4B3T over a twisted pair 13 to an RT 35. The RT 35 converts the full duplex multiplexed signals to analog service for a subscriber 12.

### CROSS-REFERENCE TO RELATED APPLICATIONS

This application is a continuation-in-part application of commonly-assigned U.S. patent application Ser. No. 08/408,020, (Attorney Docket No. MP1551-US1 /13009-002700) filed on Mar. 20, 1995 for SLC-96 PLUG-IN MULTIPLEXER, and of commonly-assigned U.S. patent application Ser. No. 08/485,460, (Attorney Docket No. 1550-US1/13009-002600) filed on Jun. 7, 1995 for 4-VF LINE MULTIPLEXER, and of commonly-assigned PCT Application No. PCT/US96/03768 published as WO 96/29841, (Attorney Docket No. MP1551-PCT1 / 13009-00271OPC) with international filing date of Mar. 20, 1996 for PLUG-IN MULTIPLEXER; and this application also claims priority from Provisional U.S. Patent Application No. 60/028,113, (Attorney Docket No. MP1551-US2) filed on Oct. 11, 1996 for PLUG-IN MULTIPLEXER. The above disclosures are incorporated by reference herein for all purposes.

### BACKGROUND OF THE INVENTION

The present invention relates to the field of telecommunications equipment. More specifically, in one embodiment the invention provides an improved method and device for providing multiple analog telephone lines from telephone company equipment such as a subscriber loop carrier (SLC) system to customer premises.

One of the SLC systems is known as the SLC-5. The SLC-5 is a digital subscriber carrier system that provides conventional telephone service, or plain old telephone services (POTS), for up to 192 subscriber lines. Other SLC systems include, for example, SLC-96 type systems, SLC-2000 type systems and the like. These types of systems use time division multiplexing techniques for transmission of signals.

FIG. 1 is a general block diagram of the basic SLC-5 system, or the like. As shown, the system provides for the use of central office switches 2, which may be digital or analog switches, to transmit up to 192 analog signals to a SLC-5 central office terminal (SLC-5 COT) 4. SLC-5 COT 4 receives the analog signals and converts the signals to T1digital format for transmission over from one to eight T1lines. The number of T1lines will depend, for example, on the operation mode, the level of activity on the VF channels, etc. An additional T1protection line may be used to increase service availability. The T1signals are transmitted to a SLC-5 remote terminal (SLC-5 RT) 6. SLC-5 RT 6 receives and converts the T1 digital signals into up to 192 analog telephone signals for transmission to subscriber equipment 12ᵢ (where i ranges from 1 to 192). The process operates in reverse to allow subscriber equipment 12ᵢ to transmit analog telephone signals to central office switches 2.

Another variation of a SLC type system operates as described above but without SLC-5 COT 4. This type of system instead includes SLC-5 RT 6 coupled via a T1 line (a digital trunk interface) to a digital switching exchange. SLC type systems may also be adapted to provide digital data such as for 4-wire digital data services (DDS) by use of an OCU/dataport channel unit.

SLC-5 RT 6 includes a common backplane 8, and shelf space for up to 96 plug-in SLC-5 dual-circuit channel units 10ⱼ (where j ranges from 1 to 96). Each dual-circuit channel unit 10ⱼ provides two VF channels, each VF channel being a 64 kbits/sec (kbps) signal corresponding to an analog telephone connection.

Backplane 8 includes the bus arrangement for accessing data in the T1 digital signals, and also includes a 4.096 MHz clock signal. In particular, backplane 8 includes pulse code modulation (PCM) buses, commonly accessible by channel units 10ⱼ. Backplane 8 has common buses for providing timing, synchronization, and telephone company power to channel units 10ⱼ. Each channel unit 10ⱼ is coupled to two subscriber lines. Each subscriber line is provided with separate analog twisted pair line 11ᵢ. Thus, channel units 10ⱼ collectively transmit 192 analog telephone signals over 192 twisted pair lines to their respective subscriber equipment 12ᵢ.

SLC-5 RT 6 would be placed, for example, in a rapidly growing suburban or rural area, any location where many customers are concentrated and telephone service demand exists, or wherever the telephone company requires. When deployed without SLC-5 COT 4, i.e. via direct T1 link into the digital switch, SLC-5 RT 6 can be located at any point between the central office and the customer, such as in the basement or the like of a high-rise building in a metropolitan area.

As customer demand rises, and as the service area expands geographically, it is desirable and economical for telephone companies to save expensive copper by reducing the number of twisted pair lines, while providing or maintaining telephone service to customers. Furthermore, telephone companies may desire to provide service where otherwise they could not, due to a lack of copper twisted pair lines between SLC-5 RT 6 and a customer location. In particular, when confronted with customer demand for service and inadequate numbers of existing twisted pair lines to meet the demand in that geographical area, telephone companies are faced with the difficult prospect of either not providing service or providing service by implementing alternative transmission links via microwave, radio, or the like, or by laying new cable. Providing service by either of these means can be labor intensive, very time consuming, unreliable and/or expensive.

It is desirable to reduce the copper (i.e., the number of twisted pair lines) necessary for the provision of telephone services to subscribers. In addition, efficiently and inexpensively providing telephone services to customers located where, for example, there is a lack of existing twisted pairs to provide service from an existing SLC-5 RT 6, is needed. Operational and testing compatibility, as well as ease, speed, and flexibility of installation, with new or existing SLC-5 systems or the like are also desirable.

### SUMMARY OF THE INVENTION

An improved system for economically and efficiently providing analog telephone service, for example, in cooperation with a SLC-5 system or other similar system is provided by virtue of the present invention. In a preferred embodiment, the invention enables the provision of analog telephone service to a large number of subscribers, but at a cost savings. Among other items, cost is saved as a result of a reduction of the number of twisted pairs normally required by a SLC system such as a SLC-5 or SLC-2000. In addition, the invention provides the ability to expand service to customers in locations where a lack of existing twisted pairs to the location makes it difficult and expensive to provide services. The invention further is able to be installed quickly and easily by plug-in to any SLC-5 RT and is compatible with new or existing SLC-5 systems or the like, as well as SLC-5 testing procedures, in accordance with a specific embodiment. Other embodiments may be plugged into other SLC type RT systems.

### BRIEF DESCRIPTION OF THE DRAWINGS

FIG. 1 is a general block diagram of a prior art system;

FIG. 2 is an overall illustration of the system, in accordance with a specific embodiment of the present invention;

FIG. 2(a) is an overall illustration of the system, in accordance with another specific embodiment of the present invention;

FIG. 2(b) is an overall illustration of the system, in accordance with a yet another specific embodiment of the present invention;

FIG. 3 is a simplified block diagram of SLC-5 plug-in multiplexer 25 according to a specific embodiment of the invention; and

FIG. 4 is a block diagram of multiplexer 25 according to another specific embodiment of the invention.

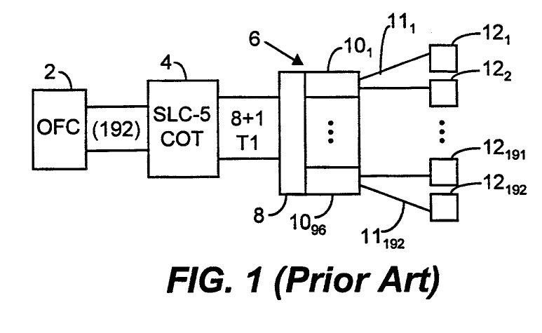

### DESCRIPTION OF THE PREFERRED EMBODIMENT

Generally, the system, according to an embodiment of the invention, provides two Message Telephone Services (MTS) (a/k/a POTS lines) over a single copper twisted pair line between multiplexer 25 and RT 35. The system uses, for example, Integrated Services Digital Network (ISDN) 2B1Q line format to transport the analog signals using the ISDN 2B+D arrangement. The ISDN 2B1Q line format supports two 64 kbps voice channels and a single 16 kbps data channel, as well as additional signaling overhead for a total of 160 kbps, over a single twisted pair. The use of an 80 kbps (a/k/a kbaud) 2B1Q signal containing 160 kbps of user information permits the transmission and reception of voice and data signals over extended lengths of twisted pair wires, e.g., 1,000, 15,000, 20,000 feet or more, without smearing, i.e., signal quality over large distances is improved because the lower frequency 80 kbps signal may be more readily separated.

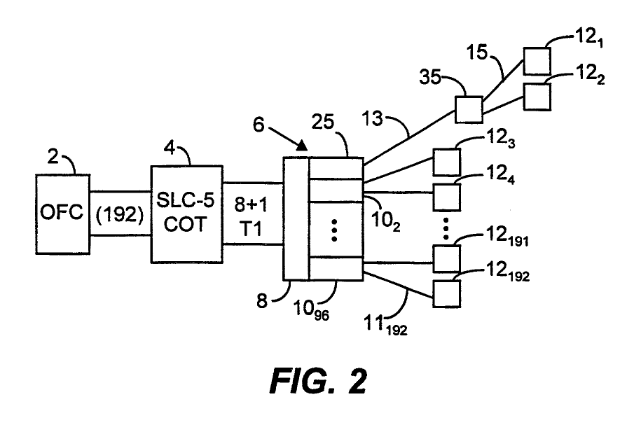

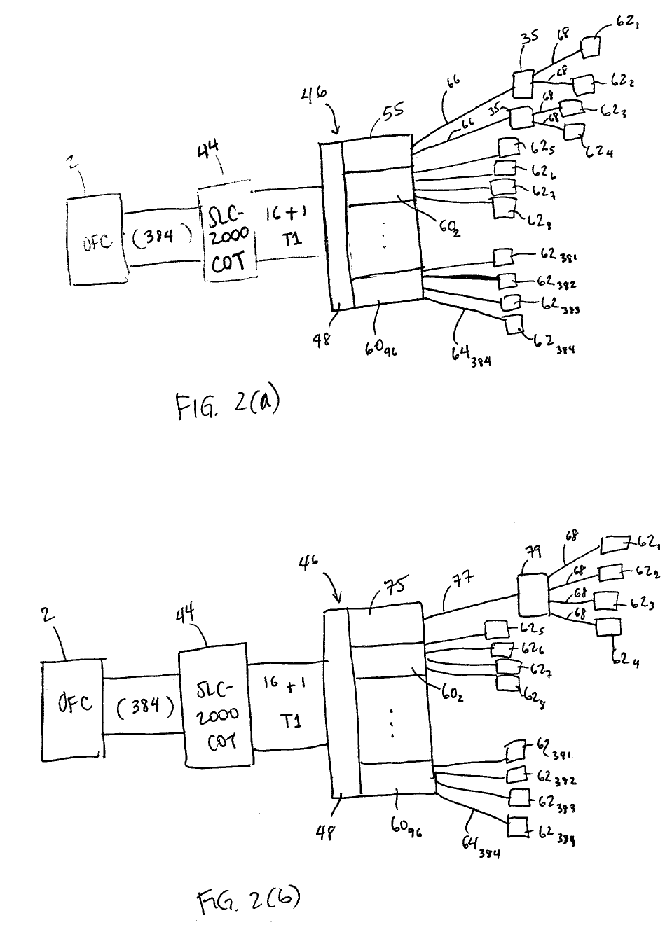

FIG. 2 illustrates a typical SLC system in accordance with an embodiment of the invention. As with a typical SLC-5 system, one or more T1digital lines provide two-way communications between SLC-5 COT 4 and SLC-5 RT 6. Of course, the invention is illustrated with regard to the T1transmission standard, but will find applicability to other standards such as E1. Any analog or digital central office switch 2 provides communications to SLC-5 COT 4. Typically, SLC-5 RT 6 includes a conventional backplane 8 and has capacity for up to 96 shelved dual-circuit channel units 10ⱼ. Each channel unit 10ⱼ corresponds, for example, to two VF channels for use by respective subscriber equipment 12ᵢ.

As seen in FIG. 2, a SLC-5 plug-in multiplexer 25 would be placed in, for example, a shelf space normally occupied by a channel unit 10ⱼ in SLC-5 RT 6. SLC-5 plug-in multiplexer 25 replaces any dual POTS-type shelved channel unit 10ⱼ in SLC-5 RT 6, by simply being plugged into a shelf space as desired or needed. The form factor of SLC-5 plug-in multiplexer 25 is the same board height and length as conventional dual-circuit channel unit 10ⱼ plug-ins on a shelf in a conventional SLC-5 RT 6. Additionally, multiplexer 25 has a faceplate including various light emitting diode (LED) indicators for providing the status of multiplexer 25 for installation or removal of multiplexer 25 without disrupting service to customers. Further, the system is testable via access relays in multiplexer 25 to a test bus in backplane through the Pair Gain Test Controller (PGTC) of a conventional SLC-5 system.

FIG. 2, merely by way of example, shows SLC-5 plug-in multiplexer 25 replacing only one shelved channel unit 10ⱼ, for a 2:1 pair gain savings on copper twisted pair lines. Of course, up to 96 SLC-5 plug-in multiplexers 25 may be used in SLC-5 RT 6, or any combination of channel units 10, and SLC-5 plug-in multiplexers 25 may be used as needed or desired. The maximum usage of the multiplexer 25/RT 35 systems in SLC-5 RT 6 could therefore result in up to a 192:96 pair gain savings on twisted pair lines. Additionally, SLC-5 plug-in multiplexer 25 may also be used in SLC-5 RT 6 for other SLC type systems which, for example, do not include SLC-5 COT 4 as described in the background.

For each SLC-5 plug-in multiplexer 25 used, a corresponding Remote Terminal (RT) 35 is used. RT 35 is coupled to multiplexer 25 via a single twisted pair line 13 over which the DSL signal travels. Subscriber equipment 12ⱼ for two subscriber lines are coupled to RT 35 via respective twisted pair lines 15. RT 35 would be placed in or near, for example, a home, office or other subscriber facility for reception of voice or data signals over the single twisted pair line from multiplexer 25. RT 35 could be located indoors or outdoors, on a pole, wall, equipment closet, or the like. Accordingly, the electronics of RT 35 are preferably enclosed in a protected enclosure installed at subscriber locations.

As will be readily apparent to those of skill in the art, the analog signal for use by a subscriber equipment 12ᵢ could be either a voice or data signal. In alternative embodiments, the signals may be used at the subscriber location for video conferencing, using one or both of the subscriber channels transmitted to each subscriber. The invention will be illustrated herein as it applies to multiplexer 25 primarily with regard to incoming signals extracted from backplane by multiplexer 25 for transmission to RT 35 for use by subscriber equipment 12ᵢ, but the process is similarly applied in reverse to provide voice and data signals from subscriber equipment 12ᵢ to RT 35 for transmission to multiplexer 25.

According to an embodiment of the invention shown in FIG. 2, multiplexer 25 interfaces with backplane of SLC-5 RT 6 to extract the appropriate two VF channels from PCM buses in backplane 8. The two extracted VF channels correspond to the two VF channels corresponding to the channel unit 10ⱼ that otherwise would occupy the shelf space that multiplexer 25 occupies. Multiplexer 25 then multiplexes the data of one VF channel and the other VF channel into the B1 and B2 channels, respectively, for transport via the 2B1Q Digital Subscriber Line (DSL) signal for transmission to RT 35 over a single twisted pair line.

RT 35 receives the DSL signal transmitted by multiplexer 25, and demultiplexes the data of the two VF channels for transmission to subscriber equipment 12ᵢ. Subscriber equipment 12ᵢ receive their respective analog signals via the respective twisted pair lines coupled between RT 35 and that subscriber equipment 12ᵢ . As shown in FIG. 2, not all of the subscriber lines need be converted in a simple SLC-5 to DSL lines. As shown in FIG. 2, some subscribers may still receive services over conventional twisted pair analog lines via conventional channel units 10ⱼ inserted in the SLC-5 RT 6. Examples of RT 35 which may be used with multiplexer 25 are further described in U.S. patent application Ser. No. 08/408,020, which has already been incorporated by reference for all purposes.

While the preferred embodiment of the invention is illustrated by way of example with regard to providing two VF channels, other embodiments of the invention may also be implemented to provide digital service as well. Still further embodiments may provide multiplexers for use with a SLC-2000 COT 44, which is connected to the central office 2, and SLC-2000 RT 46 such as shown in FIG. 2(a) and FIG. 2(b). For example, a plug-in multiplexer (55 or 75) according to specific embodiments of FIGS. 2(a) or FIG. 2(b) plugs into a backplane 48 of SLC-2000 RT 46 which has a capacity for up to 96 shelved quad-circuit channel units ⁶⁰k (where k is from 1 to 96), where each quad-circuit channel unit 60ₖ corresponds to four VF channels for provision to subscriber equipment 62ₘ (where m is from 1 to 384) over a respective twisted pair line 64ₘ. An embodiment of such a SLC-2000 plug-in multiplexer 55 shown in FIG. 2(a) may interface with backplane 48 and provide two multiplexed 2B +D signals (using 2B1Q or 4B3T line coding) to two respective twisted pair DSLs 66 to a respective RT 35 (similar to that RT 35 which may be used with multiplexer 25 of the specific embodiment described for FIG. 2) that demultiplexes the respective multiplexed signal such that the two RTs 35 provide a total of four voice channels over respective twisted pair lines 68 to four subscriber equipment 62. The maximum usage of multiplexer 55 in SLC-2000 RT 46 could result in up to a 384:192 pair gain savings on twisted pair lines. An alternative embodiment of such a SLC-2000 plug-in multiplexer 75 shown in FIG. 2(a) may interface with backplane 48 and provide a multiplexed 4B+D signal (using 2B1Q or 4B3T line coding) to a single twisted pair HDSL 77 to a corresponding RT 79 (similar to that 4-VF RT 106 which is described in U.S. patent application Ser. No. 08/485,460, which has already been incorporated by reference for all purposes) that demultiplexes the multiplexed signal and provides four voice channels over respective twisted pair lines 68 to four subscriber equipment 62. The maximum usage of multiplexer 75 in SLC-2000 RT 46 could result in up to a 384:96 pair gain savings on twisted pair lines. In still further embodiments, SLC-2000 plug-in multiplexer 55 or 75 could be used with a SLC-2000 RT 46 which is directly connected to a central office switch 2 via T1or E1 or fiber lines without a SLC-2000 COT. Similarly, SLC-5 plug-in multiplexer 25 could also be used with a SLC-5 RT 6 which is directly connected to a central office switch 2 via T1or E1 lines without a SLC-5 COT, in accordance with another specific embodiment. In some embodiments, SLC-5 plug-in multiplexer 25 also could be used with a SLC-2000 RT 46 to provide two VF channels.

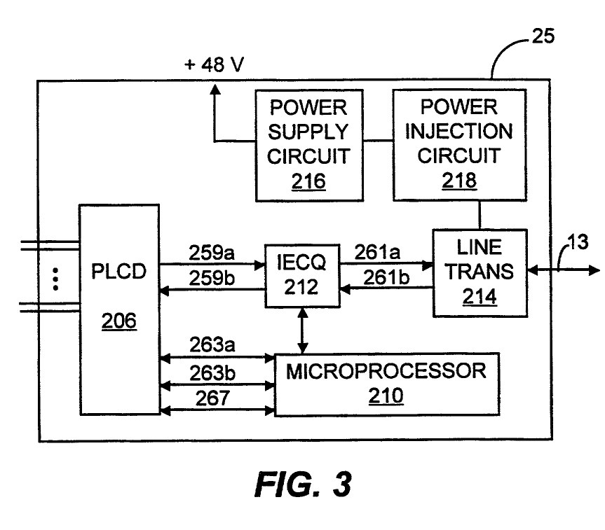

In accordance with another specific embodiment of the present invention similar to the embodiment of FIG. 2, FIG. 3 is a simplified block diagram of multiplexer 25. Multiplexer 25 includes a SLC-5 backplane 8 interface circuit implemented by means of a programmable logic control device (PLCD) 206, a microprocessor 210, an ISDN Echo Cancellation-Quaternary (IECQ) chip 212, a line transformer 214, a power supply circuit 216, and a power injection circuit 218.

The PLCD 206 is coupled to backplane and provides the interface for data and control signals between multiplexer 25 and backplane of SLC-5 RT 6. According to an embodiment of the invention, PLCD 206 extracts PCM signals of the appropriate VF channels from backplane 8, and also extracts a 4.096 MHz timing signal from backplane 8. PLCD 206 also provides the interface for multiple control signals between multiplexer 25 and backplane 8. Framing alignment signals are available from backplane 8, and PLCD 206 uses the signals extracted from PCM buses in backplane for clock timing and multiplexing functions in the PLCD 206.

PLCD 206 multiplexes the two 8-bit PCM signals with bits of control data and bits of monitor channel data, and transmits these 8-bit PCM words over a half duplex link to the IECQ 212 via a 256 kbps transmit signal sent to IECQ 212 via line 259a and a 256 kbps receive signal sent from IECQ 212 via line 259b. Multiplexer 25 includes software that uses the time slot active information available from backplane to extract the appropriate PCM data signals from backplane 8.

IECQ 212 converts the signal from PLCD 206 to 160 kbps of user information (144 kbits of user data, plus 16 kbits of ISDN U-interface framing that contains embedded operations channel (EOC) M-bits, CRC, and error monitoring). IECQ 212 also converts the 160 kbps binary signal to an 80 kbps quaternary signal for transmission to RT 35 over twisted pair line 13. For an outgoing signal in the direction from backplane toward RT 35, the 80 kbps 2B1Q signal containing 160 kbps of user information is transmitted via line 261a to line transformer 214 for transmission over twisted pair line 13. For an incoming signal in the direction from RT 35 toward backplane 8, the signal received over twisted pair line 13 is transmitted from line transformer 214 to IECQ 212 via line 261b.

Line transformer 214, providing 4-wire to 2-wire conversion, serves isolation and impedance matching functions. The DSL signal transmitted by multiplexer 25 enters RT 35 over a conventional twisted pair line 13, which may be the type commonly used in households, offices, or the like. The DSL signal from multiplexer 25 is an 80 kbps signal having one of four voltage levels (2B1Q). While the invention is illustrated herein with regard to the preferred 80 kbps signal, it is believed that the invention herein would find utility using signals of between about 50 and 100 kbps, and preferably between 70 and 90 kbps. Using other standards, such as 4B3T (a ternary signal), other rates may be desirable such as 120 kbps. The data rates and standards used herein are of course only illustrative and will of course vary from one system to the next and as the underlying technologies evolve.

Power supply circuit 216 converts -48 V voltage from the telephone company battery power from backplane to supply the +5 V needed to supply power to multiplexer 25. In addition, power supply circuit 216 converts the -48 V to supply the -135 V and 0 V to power injection circuit 218. Power injection circuit 218 injects -135 V and 0 V from power supply circuit 216 into the DSL signal to line power RT 35 at the subscriber premises, without use of a battery or other power source at the site of RT 35. An advantage of the use of -135 V and 0 V to line power RT 35 is that less corrosion occurs at RT 35. Of course, other embodiments of the invention may power RT 35 at its remote site using AC wall unit supplied power or the like.

In general, PLCD 206 provides input/output (I/O) port integration functions usually handled by microprocessor bus expansion chips like buffers, latches and multiplexers. PLCD 206 includes an internal field programmable gate array (FPGA) area that is used to implement various timing as well as backplane interface functions. As this internal FPGA area is not readable after PLCD 206 has been programmed, advantages of the system include, for example, security for the functional design.

PLCD 206 is coupled to microprocessor 210 and IECQ 212. PLCD 206 receives multiple input signals from backplane and outputs multiple control signals to backplane 8. In particular, PLCD 206 asserts various timing signals for enabling transmission or reception of signals to and from backplane 8. PLCD 206 also asserts control signals to backplane to determine when a channel slot is active. The PLCD 206 FPGA helps decode which channel slot is occupied by multiplexer 25 and thus determine when that channel is active on the PCM bus.

For incoming signals, PLCD 206 controls access to the PCM bus and outputs the appropriate digital signals for input to IECQ 212. PLCD 206 builds each 64 kbps DSO and multiplexes the two DSO signals (B1 and B2) into the 256 kbps signal to the IECQ 212.

The functionality of multiplexer 25 is overseen by microprocessor 210. Microprocessor 210 receives a frame control signal (FSC) at, for example, about kHz. PLCD 206 and IECQ 212 also operate on the FSC signal and on a clock signal at, for example, about 256 kHz. Microprocessor 210 is coupled to PLCD 206 over a data bus line 263a and an address bus line 263b. PLCD 206 is also coupled to microprocessor 210 via bus 267 for various control and clock signals.

The functionality of the PLCD 206 may be performed by a ROM, a custom integrated chip, an application specific integrated chip (ASIC) or in the microprocessor 210. Conversely, most or all of the functions of the microprocessor 210 may be performed in the PLCD 206.

As will be apparent to one of ordinary skill in the art, outgoing signals from the subscriber are processed in a similar but reverse method from incoming signals.

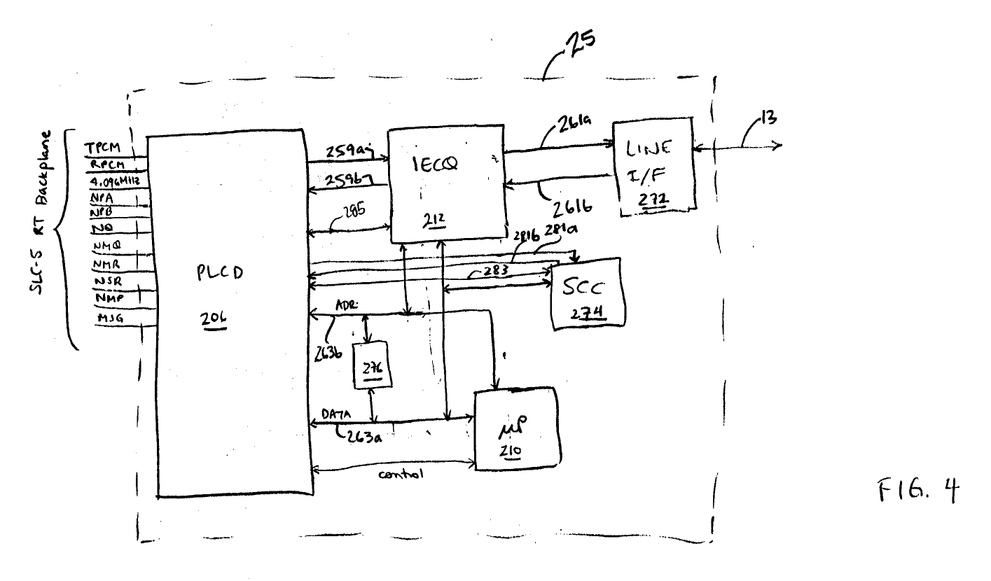

FIG. 4 provides a block diagram of multiplexer 25 according to another specific embodiment of the invention. In the present embodiment, multiplexer 25 includes PLCD 206, IECQ chip 212, a line interface 272, microprocessor 210, a serial communications controller (SCC) 274, and a latch 276, as well as power injection circuit 218 and power supply circuit 216 (for simplicity, both not shown in FIG. 4).

The functionalities of PLCD 206, IECQ 212, microprocessor 210, power injection circuit 218 and power supply circuit 216 in the present embodiment are generally similar to those described above. Microprocessor 210 controls initialization and control of IECQ 212, SCC 274, and power supply circuit 216, as well as signaling messages and controlling test relays and front panel indicators of multiplexer 25. Appendix I (© Copyright, Unpublished Work, Raychem Corporation) provides the software for operation of the microprocessor 210 according to an embodiment of the invention. In this embodiment, line interface 272 converts between a 4-wire format and a 2-wire format and provides DC isolation and protection (lightning and power cross protection of the rest of multiplexer 25) from the 2-wire line 13.

In the present embodiment shown in FIG. 4, PLCD 206 provides the interface between multiplexer 25 and backplane 8, which includes signal lines TPCM, RPCM, 4.096 MHz clock, NPA, NPB, NQ, NMQ, NMR, NSR, NMP, and MSG, described in further detail below. For incoming signals received in the direction from backplane toward RT 35, PLCD 206 appropriately latches and then multiplexes the PCM data (two B-channels) serially received from the RPCM bus of backplane and the D-channel data on line 28b from SCC 274 to provide the 2B+D data over line 259a to IECQ 212, which transmits the data to line interface 272 over line 261a to RT 35 for transmission over the single twisted pair 13. For outgoing signals received in the direction from RT 35 toward backplane 8, PLCD 206 demultiplexes the 2B +D data received on line 259b from IECQ 212 (and from line interface 272 on line 261b) into PCM data (two B-channels) and D-channel data. The D-channel data is sent on line 281a to SCC 274 and the two B-channel PCM data are appropriately latched and serially transmitted to the RPCM bus for use at backplane 8. Since TPCM and RPCM each is a time division multiplexed serial bus with thirty-two 16-bit wide time slots with a frame repeat rate of kHz. The NQ, NPA, NPB, RPCM and TPCM signals are all synchronized to the 4.096 MHz clock signal received from backplane 8. For accessing the appropriate two channel unit time slots associated with the channel unit 10ⱼ that multiplexer 25 replaces, the NQ (group select) and either NPA (odd channel select) or NPB (even channel select) signals both being simultaneously active indicates that the PCM frame for either the odd channel or the even channel, respectively, is available for either transmitting (TPCM) to backplane or receiving (RPCM) from backplane 8. The format for the 16-bit time slot (for both receive and transmit) is bits of PCM data in the normal DSO format, followed by four signaling bits, three unused bits, and a parity bit. PLCD 206 includes logic that detects the frame sync indicators and shifts in the received data and latches it into registers for transmission to IECQ 212. The signaling bits received from RT 35 are available to microprocessor 210 from registers in PLCD 206, and microprocessor 210 accesses other registers in order to generate a signaling message to RT 35. Lines 259a and 259b are respectively the lines for transmitting 2B+D data from PLCD 206 to IECQ 212 and for receiving 2B+D data from IECQ 212 to PLCD 206. Line 285 represents the frame synchronization (e.g., FSR and FSX) and clock (e.g., data clock at 512 kHz for a basic frame rate of kHz) signals provided by PLCD 206 to IECQ 212. The D-channel information is interfaced from PLCD 206 to SCC 274 for framing via microprocessor 210.

In addition to providing multiplexing and demultiplexing of 2B +D data, PLCD 206 also performs message control functions between multiplexer 25 and backplane via NSR, NMP, NMQ, and MSG signal lines shown in FIG. 4. The MSG signal line is a bi-directional serial message line. NSR (message bus service request), NMP (message bus select) and NMQ (message bus clock) being simultaneous active indicates the existence of an actual message on the MSG line that is intended for the card that multiplexer 25 replaces. Commands on the MSG line may be sent from backplane by the SLC-5 backplane control unit, and PLCD 206 generates acknowledgements or replies to these commands. Messages may be used for initialization, test access relay status polling, ID requesting, and/or indicating test mode (e.g., Pair Gain Test Controller (PGTC) or Mechanized Loop Testing (MLT)).

PLCD 206 also provides interfaces for the address and data buses (263b and 263a, respectively) of microprocessor 210. PLCD 206 performs address decoding and generates chip selects for IECQ 212 and SCC 274, as well as providing access to PCM signaling bits for message control. PLCD 206 also may include a programmable read-only memory (PROM), which is not shown for simplicity in FIG. 4, that contains configuration data such as checksums to be verified upon loading. Appendix II (© Copyright, Unpublished Work, Raychem Corporation) provides software for programming the PLCD 206, in accordance with a specific embodiment.

SCC 274 provides framing of the D-channel signaling messages to and from RT 35 and allows microprocessor 210 to transmit and receive these signaling messages. For incoming signals received in the direction from backplane toward RT 35, SCC 274 receives D-channel data from PLCD 206 via line 281a. For outgoing signals received in the direction from RT 35 toward backplane 8, SCC 274 transmits D-channel data via line 281b to PLCD 206. Various clock and control signals (e.g., 4.096 MHz clock, read/write, chip enable, etc.) between PLCD 206 and SCC 274 are represented as lines 283. The 4.096 MHz clock signal is used to clock internal data for SCC 274 for its microprocessor interface to facilitate control by microprocessor 210 of the D-channel data transmission to and from SCC 274 and PLCD 206. In addition to framing/deframing, SCC 274 also performs CRC (cyclic redundancy check) generation/checking. It is recognized that in some specific embodiments, the functionality of SCC 274 may be incorporated into PLCD 206 (e.g., embodiment shown in FIG. 3) or performed by software controlling microprocessor 210.

According to some specific embodiments, the data bus line 263a and address bus line 263b may be coupled to chip 276, which may be a Texas Instruments 74HCT373 or the like, to provide an effective 16-bit bus functionality. Acting as a separate low address bus, chip 276 acts as a latch for holding the low address data when ALE is low.

Without in any way limiting the scope of the invention, Table 1 provides a list of commercially available components which are useful in operation of the multiplexer according to the above embodiments. It will be apparent to those of skill in the art that the components listed in Table 1 are merely representative of those which may be used in association with the invention herein and are provided for the purpose of facilitating assembly of a device in accord with the invention. A wide variety of components readily known to those of skill in the art could readily be substituted or functionality could be combined or separated. It should be noted that CMOS-based devices have been utilized where possible (e.g., the microprocessor) so as to reduce power consumption of SLC-5 Plug-in Multiplexer 25 and RT 35 in particular.

TABLE 1
SLC-5 Plug-in Multiplexer Components

| | |
|---|---|
| IECQ 212 | Motorola MC145572 |
| PLCD 206 | XILINX XC5210 |
| Serial Communications | Zilog Z85C30 or AMD AM85C30 |
| Controller 274 | |
| Microprocessor 210 | Intel 80C31, 80C51, 87C51 |
| | or Motorola MC68LC302 |

It is to be understood that the above description is intended to be illustrative and not restrictive. Many embodiments will be apparent to those of skill in the art upon reviewing the above description. By way of example the inventions herein have been illustrated primarily with regard to transmission of voice and data signals (POTS) in SLC-5 systems, but they are not so limited. For example, the inventions could be applied in the transmission and reception of radio and TV signals, telephoto, teletype, facsimile, and other signals. By way of further example, the inventions have been illustrated above with reference to the simultaneous transmission of two signals over a single twisted pair, but the inventions could readily be extended to transmit 3 or more signals simultaneously over a single twisted pair. The scope of the inventions should, therefore, be determined not with reference to the above description, but should instead be determined with reference to the appended claims, along with the full scope of equivalents to which such claims are entitled.

What is claimed is:

1. A telephony system for transmitting signals to and from a subscriber line comprising:
a subscriber line carrier unit comprising a backplane and a plurality of channel unit slots, each channel unit slot coupled to said backplane, said backplane coupled to multiple telephone company PCM lines;
a channel unit in at least one of said channel unit slots, said channel unit comprising a multiplexing circuit for converting signals on said PCM lines to multiplexed, full duplex digital signals for transmission over a twisted pair; and
a remote terminal at a subscriber location, said remote terminal converting said multiplexed, full duplex digital signals on said twisted pair to subscriber service for at least two telephone lines at said subscriber location.

2. The system as recited in claim 1 wherein said PCM lines are T1lines.

3. The system as recited in claim 1 wherein said PCM lines are E1 lines.

4. The system as recited in claim 2 wherein up to nine of said T1 lines are input to said subscriber line carrier for generation of 192 subscriber lines.

5. The system as recited in claim 1 further comprising other channel units in said subscriber line carrier unit, said other channel units outputting analog signals to other subscribers over analog twisted pairs.

6. The system as recited in claim 1 wherein said multiplexed full duplex signals are 2B1Q signals.

7. The system as recited in claim 1 wherein said multiplexed full duplex signals are 4B3T signals.

8. The system as recited in claim 1 wherein said subscriber line carrier unit is coupled to a subscriber line central office unit, said subscriber line central office unit inputting analog signals from a central office switch, and outputting said PCM lines.

9. The system as recited in claim 1 wherein said channel unit comprises:
a PLCD circuit for interfacing to said backplane and for inputting T1signals and outputting duplexed digital time multiplexed signals;
an IECQ circuit coupled to said PLCD circuit for inputting said transmit digital signals and outputting quaternary signals; and
a line transmission circuit for inputting said quaternary signals and outputting two-wire quaternary signals.

10. The system as recited in claim 9 further comprising a programmable logic device for generating and receiving control signals to and from said backplane.

11. The system as recited in claim 1 wherein said subscriber service for at least two telephone lines is analog service.

12. The system as recited in claim 2 wherein up to 17 of said T1 lines are input to a subscriber line carrier of 384 carrier lines.

13. The system as recited in claim 12 wherein said multiplexing circuit in said channel unit converts signals on said PCM lines to a first multiplexed, full duplex digital signal for transmission over said twisted pair and to a second multiplexed, full duplex digital signal for transmission over a second twisted pair, and wherein said remote terminal converts said first multiplexed, full duplex digital signal on said twisted pair to subscriber service for first and second telephone lines at said subscriber location and converts said second multiplexed, full duplex digital signal on said second twisted pair to subscriber service for third and fourth telephone lines at said subscriber location.

14. The system as recited in claim 12 wherein said remote terminal converts said multiplexed, full duplex digital signal on said twisted pair to subscriber service for first, second, third, and fourth telephone lines at said subscriber location.

15. A method of using a subscriber line carrier, said subscriber line carrier comprising a plurality of channel unit slots, said channel unit slots adapted to receive channel units, said channel units adapted to each generate multiple analog telephony signals and transmit each of said multiple analog telephony line signals over corresponding twisted pair wires, comprising the step of installing a multiplex channel unit, said multiplex channel unit transmitting multiple telephony line signals over a single twisted pair; and converting said multiple telephone line signals to analog services at a subscriber location.

16. The method as recited in claim 15 wherein said subscriber line carrier is a SLC-5 and said SLC-5 inputs multiple T1signals.

17. The method as recited in claim 15 wherein said channel units are adapted to generate two analog telephony line signals for transmission over two corresponding twisted pair wires, and said multiplex channel units are adapted to transmit two telephony line signals over said twisted pair.

18. The method as recited in claim 15 wherein said multiple telephony line signals are transmitted using a 2B1Q line coding standard.

19. The method as recited in claim 15 wherein said multiple telephony line signals are transmitted using a 4B3T line coding standard.

20. The method as recited in claim 16 wherein said T1signals are generated from multiple analog signals at a central office switch.

21. A method comprising:
inputting multiple T1lines to a subscriber line carrier; and
installing a multiplex channel unit, said multiplex channel unit inputting multiple telephone lines in said T1format, and outputting two telephone lines on a single twisted pair in a 2B1Q or 4B3T line coding format; and
wherein said multiplexer plugs into a channel unit shelf space of the SLC-5 or SLC-2000 remote terminal.

22. The method as recited in claim 21 wherein said multiplexer interfaces with a backplane of said SLC-5 or SLC-2000 remote terminal and said backplane includes multiple outgoing backplane signals comprising pulse code modulation (PCM) signals.

23. The method as recited in claim 21 wherein said single channel and said telephone lines comprise 4-wire digital data service (DDS) channels, and wherein said multiplexer interfaces with a backplane of said SLC-5 or SLC-2000 remote terminal and said backplane includes multiple outgoing backplane signals comprising digital data bus signals.
